(19) United States
(12) Patent Application Publication
(10) Pub. No.: US 2015/0281843 A1
(43) Pub. Date: Oct. 1, 2015

(54) DIAPHRAGM SURROUND MANUFACTURING METHOD AND DIAPHRAGM APPLICABLE THERETO

(71) Applicant: MERRY ELECTRONICS (SUZHOU) CO., LTD., Suzhou City (CN)

(72) Inventors: Teng-Yang CHAN, Taichung City (TW); Wen-Hong WANG, Taichung City (TW)

(73) Assignee: MERRY ELECTRONICS (SUZHOU) CO., LTD., Suzhou City (CN)

(21) Appl. No.: 14/226,040

(22) Filed: Mar. 26, 2014

(51) Int. Cl. H04R 7/00; H04R 31/00

(52) U.S. Cl. CPC H04R 7/00; H04R 31/00; H04R 2207/00

(57) ABSTRACT

A diaphragm surround manufacturing method includes: mixing a molten plastic and a gas in supercritical fluid state in a feed pipe of an injector to form a mixture; filling a die with the mixture thus formed and controlling pressure and temperature of the die to cause the gas to diffuse and nucleate inside the die and develop a plurality of bubbles; and reducing the temperature of the die to cause the plastic to cure and form a microcellular foam structure. Accordingly, the surround manufactured by the manufacturing method has equal foam cell diameters and uniform foam cell distribution so as to enhance the tensile strength of the surround, enable a diaphragm with the surround to perform well at low frequencies, and extend the service life of the diaphragm.

### BACKGROUND OF THE INVENTION

1. Technical Field

The present invention relates to diaphragms of electro-acoustic products, and more particularly, to a method of manufacturing a diaphragm surround with a microcellular foam structure and a diaphragm manufactured by the manufacturing method.

2. Description of Related Art

The surrounds of speakers are for use in fixing diaphragms in place. In this regard, a surround not only ensures the axial degree of freedom of a diaphragm but also prevents the diaphragm from moving laterally. Hence, the thickness, materials, and structure of diaphragm surrounds have certain effect on speaker frequency response and timbre. Commercially-available surrounds are made of various materials, such as fabric, rubber, and foam. Speakers with surrounds made of foam are capable of producing soft gentle sounds and thus popular with some users.

A conventional method of manufacturing foam requires mixing a chemical foaming agent and a molten plastic, heating the mixture until the mixture undergoes a reaction to release a gas, and causing the plastic to foam and thus take shape. However, the foam structure manufactured by the conventional foaming method is usually flawed with defects, such as unequal foam cell diameters and uneven foam cell distribution. As a result, if diaphragm surrounds are manufactured by the conventional foaming method, the diaphragm surrounds thus manufactured are confronted with two problems: first, insufficient tensile strength, which compromises the acoustic quality of speakers operating at low frequencies; second, uneven structural strength, which predisposes the diaphragm surrounds to wear and tear, thereby shortening the service life of the diaphragms.

### SUMMARY OF THE INVENTION

In view of the aforesaid drawbacks of the prior art, it is an objective of the present invention to provide a diaphragm surround manufacturing method whereby a diaphragm surround thus manufactured not only has a delicate foam structure and enhanced tensile strength but also allows a diaphragm to perform well in terms of frequency response at low frequencies.

Another objective of the present invention is to provide a diaphragm surround manufacturing method such that the surround thus manufactured has a long service life.

In order to achieve the above and other objectives, the present invention provides a diaphragm surround manufacturing method, comprising the steps of: a) mixing a molten plastic and a gas in supercritical fluid state in a feed pipe of an injector to form a mixture; b) filling a die with the mixture formed in step a) and controlling pressure and temperature of the die to cause the gas to diffuse and nucleate inside the die and develop a plurality of bubbles; and c) reducing the temperature of the die to cause the plastic to cure and form a microcellular foam structure.

Accordingly, the surround manufactured by the manufacturing method has equal foam cell diameters and uniform foam cell distribution so as to enhance the tensile strength of the surround, enable a diaphragm with the surround to perform well in terms of frequency response at low frequencies, render the surround insusceptible to wear and tear, and extend the service life of the surround.

### BRIEF DESCRIPTION OF THE SEVERAL VIEWS OF THE DRAWINGS

The features of the present invention are hereunder illustrated with a preferred embodiment in conjunction with the accompanying drawings, in which:

FIG. 1 is a flow chart of a diaphragm surround manufacturing method according to a preferred embodiment of the present invention;

FIG. 2 is a cross-sectional view of a diaphragm with a square surround according to the present invention;

FIG. 3 is a cross-sectional view of a diaphragm with a rectangular surround according to the present invention;

FIG. 4 is a cross-sectional view of a diaphragm with a runway-like surround according to the present invention;

FIG. 5 is a cross-sectional view of a diaphragm with a round surround according to the present invention.

### DETAILED DESCRIPTION OF THE EMBODIMENT OF THE INVENTION

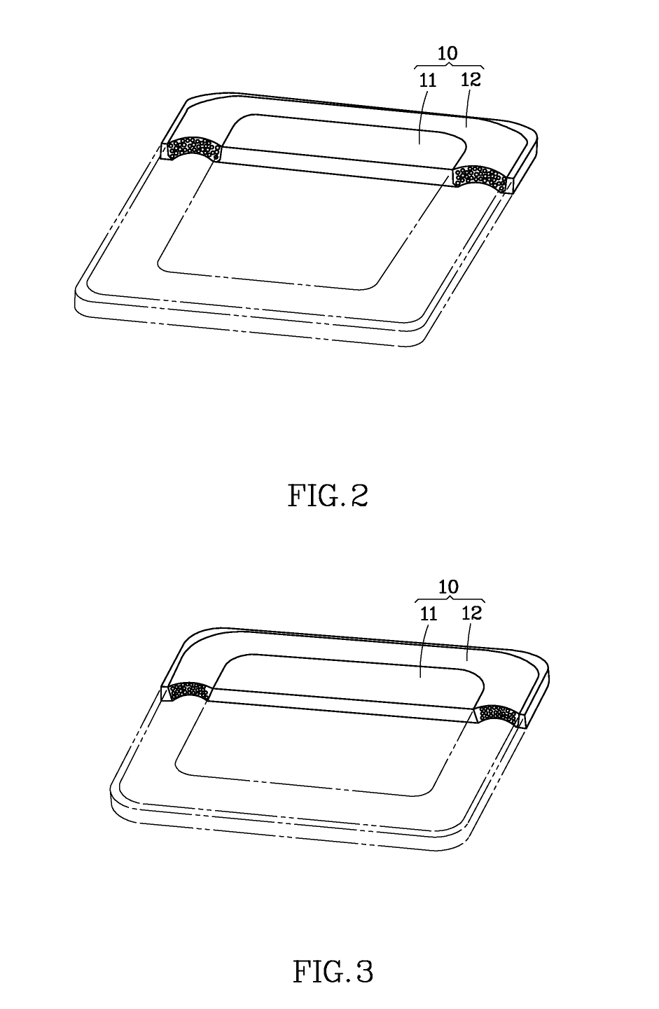

Referring to FIG. 2, in an embodiment of the present invention, a diaphragm 10 is for use with an electro-acoustic product. The diaphragm 10 has a central portion 11 and a surround 12. The surround 12 is manufactured by a microcellular foaming process (MuCell) whose process flow is described below.

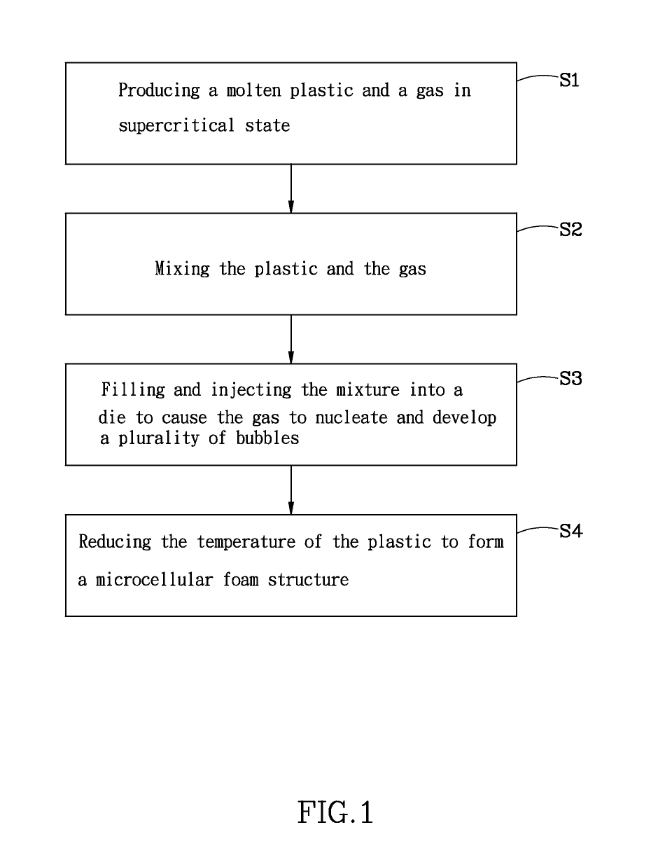

Referring to FIG. 1, step S1 involves producing a molten plastic and a gas in supercritical fluid (SCF) state, which are exemplified by polypropylene (PP) and carbon dioxide, wherein two requirements for carbon dioxide to be in supercritical fluid state are, namely a critical temperature of 31° C. and a critical pressure of 1072 psi. Step S1 is followed by step S2. Step S2 involves delivering the plastic and gas into a feed pipe (not shown) of an injection molding machine to mix the plastic and gas therein, so as to form a non-nucleated, homogeneous, and fluidic mixture. At this point in time, the temperature and pressure inside the feed pipe is placed under control to enable the gas to demonstrate a high solubility in the plastic.

Upon completion of the aforesaid mixing procedure, step S3 begins. Step S3 involves delivering, in a fill/inject mode, the mixture formed from the plastic and gas into a die (not shown) such that the mixture therein takes an annular shape, wherein during the quick ejection process the mixture acquires a high pressure-drop speed and thus becomes so unstable that the gas forms plenty of nucleation points inside the plastic to further control the pressure and temperature inside the die, such that inside the die a plurality of microcellular bubbles develop from the nucleation points.

Finally, step S4 involves reducing the temperature of a die 40 to cool and cure the plastic; meanwhile, the diameters of the bubbles stop increasing, such that the surround thus manufactured forms therein a microcellular foam structure. The microcellular bubbles produced by the microcellular foaming process are not only tiny but are also uniformly distributed, and thus the surround manufactured according to the present invention manifests high toughness and high tensile strength not found in low-foaming-density foamed plastics manufactured by the conventional manufacturing method.

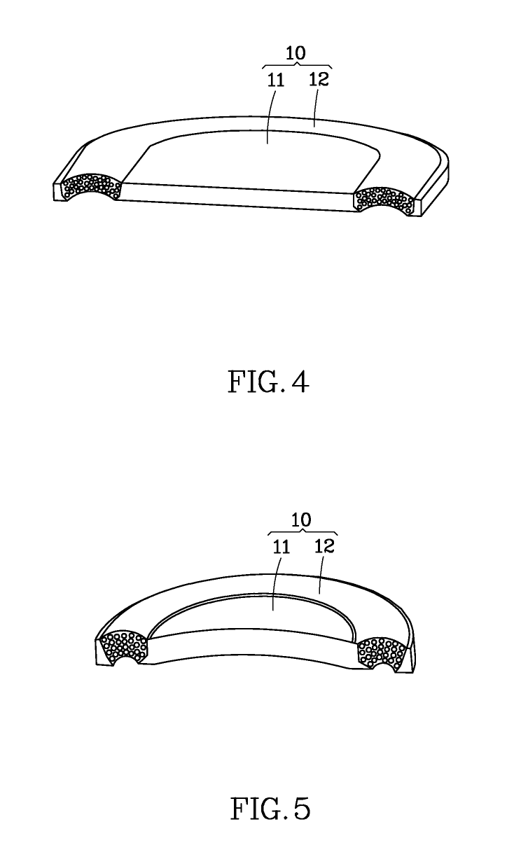

Furthermore, in step S3, a portion of the molten plastic, which does not mix with the gas, is delivered into the die and positioned in the central area of the annular surround. Afterward, in step S4, the aforesaid portion of the molten plastic of step S3 and the mixture are cooled and cured together to form the integrally-formed diaphragm 10 in step S4. Referring to FIG. 2, the diaphragm 10 comprises the surround 12 with a microcellular foam structure and the panel-shaped central portion 11. The surround 12 is designed to be square (as FIG. 2), rectangular (as FIG. 3), runway-like (as FIG. 4), or round (as FIG. 5) as needed, and is disposed along the outer rim of the central portion 11.

The manufacturing method of the present invention not only improves the mechanical properties of the surround 12 but also enables the central portion 11 to operate within the optimal dynamic range while the diaphragm 10 is vibrating at low frequency, so as to prevent distortion of the sound produced at a high power and ensure a long service life of the diaphragm 10.

The constituent elements disclosed in the embodiment of the present invention serve an illustrative purpose but are not intended to restrict the scope of the disclosure of the present invention. All the other readily conceivable structural changes or the replacement and variation of the other equivalent elements should fall within the claims of the present invention.

What is claimed is:

1. A diaphragm surround manufacturing method, comprising the steps of:
a) mixing a molten plastic and a gas in supercritical fluid state in a feed pipe of an injector to form a mixture;
b) filling a die with the mixture formed in step a) and controlling pressure and temperature of the die to cause the gas to diffuse and nucleate inside the die and develop a plurality of bubbles; and
c) reducing the temperature of the die to cause the plastic to cure and form a microcellular foam structure.

2. The diaphragm surround manufacturing method of claim 1, wherein, in step b), the mixture takes on an annular shape.

3. The diaphragm surround manufacturing method of claim 1, wherein, in step b), a portion of the plastic, which does not mix with the gas, is delivered into the die and positioned centrally at the mixture, and then, in step c), the aforesaid portion of the plastic of step b) and the mixture are cooled and cured together to form the integrally-formed diaphragm in step c).

4. A diaphragm with a central portion and a surround disposed along a rim of the central portion, characterized in that at least a portion of the surround has a microcellular foam structure manufactured by the manufacturing method of claim 1.

5. The diaphragm of claim 4, wherein the surround is of one of a rectangular shape, a round shape, and a runway-like shape.

6. The diaphragm of claim 4, wherein the surround is annular and has a microcellular foam structure fully.

7. The diaphragm of claim 6, wherein the central portion and the surround are integrally formed.
